(19) United States
(12) Patent Application Publication
(10) Pub. No.: US 2024/0215554 A1
(43) Pub. Date: Jul. 4, 2024

(54) REAL-TIME TENSION MONITORING FOR AQUACULTURE PEN DYNAMICS

(71) Applicant: X Development LLC, Mountain View, CA (US)

(72) Inventors: Harrison Pham, Sunnyvale, CA (US); Thomas Robert Swanson, Sunnyvale, CA (US)

(21) Appl. No.: 18/240,075

(22) Filed: Aug. 30, 2023

Related U.S. Application Data
(60) Provisional application No. 63/436,451, filed on Dec. 30, 2022.

(51) Int. Cl. A01K 63/00; A01K 61/60

(52) U.S. Cl. CPC A01K 63/006; A01K 61/60

(57) ABSTRACT

A method for monitoring an aquaculture net, including: transmitting, from a sensor coupled to a net, a signal including information indicative of one or more net state parameters through water; receiving the signal from a sensor coupled to a net, the signal including information indicative of one or more net state parameters; extracting the information from the signal; applying the extracted information as input to a machine learning model trained to determine a net state from the extracted information; determining the presence of a defect in the net.

### CROSS-REFERENCE TO RELATED APPLICATIONS

This application claims the benefit of U.S. Application No. 63/436,451, filed on Dec. 30, 2022, the contents of which are hereby incorporated by reference.

### FIELD OF THE DISCLOSURE

The disclosure relates to real-time tension monitoring and more specifically, to real-time underwater tension monitoring in aquaculture nets.

### BACKGROUND

Aquaculture is a marine farming technique in which farms for marine life are placed offshore and/or in freshwater sources. Aquaculture pens are large and flexible enclosures for maintaining marine life populations in controlled areas of the water. The nets can develop bulges and move around due to prevailing currents, and can be damaged by abrasion, impact from boats, local fauna, or pen equipment. The nets can also develop biofouling which increases drag and generates stiffer forces on the net. Net inspection is currently a manual process and requires sending a diver or camera down with a human operator to look for damage or holes. Further, manual processes are often time-consuming, expensive, inaccurate, and can be delayed, such as when work schedules or adverse weather conditions decrease the availability of human monitors.

When fish escape through a torn net of a pen, remediation efforts typically involve attempting to catch and return the escaped fish, such as by hiring sport fishers or the use of Fjord nets. However, these methods tend to be both expensive and ineffective. Further, updated net dynamics models are needed because net structure and dynamics are too complex and varied to be described by traditional static models. Different nets behave differently based on design, environment, and specific installation.

### SUMMARY

Provided in this disclosure are methods for monitoring aquaculture nets using distributed net monitoring devices. Stress-sensing devices are releasably attached to the net and create and maintain tension in the strands of the net. The devices produce impulse signals through the attachment points which traverse the net to be received by other attached net monitoring devices. The devices are networked using acoustic modems to a control device which receives signals indicative of the tension sensed by the net monitoring devices. The devices generate power from motion sufficient to power the integrated components of the devices. The devices outputs regular, e.g., scheduled, or irregular signals, e.g., in response to a command, through the surrounding water.

The control device for the net monitoring system receives the signals from the water and performs real-time signal processing. The signal processing can include cleaning the received signals, applying a trained machine learning model to determine characteristics of the net, generating data for presentation to a user device, or generating one or more alerts. The control device communicates with networked devices which apply trained machine learning model classifiers to determine various net state parameters, such as the presence of a defect in the net. The machine learning models disclosed herein include a training phase where it applies impulses and monitors net dynamics to determine how a healthy net behaves. After training, the model(s) monitor for anomalies in how the net responds to external stimuli and to device-generated impulses.

In a first aspect, disclosed herein is a method for monitoring an aquaculture net, including: transmitting, from a sensor coupled to a net, a signal including information indicative of one or more net state parameters through water; receiving the signal from a sensor coupled to a net, the signal including information indicative of one or more net state parameters; extracting the information from the signal; applying the extracted information as input to a machine learning model trained to determine a net state from the extracted information; determining the presence of a defect in the net.

### Embodiments can Include the Following Features

The method can further include, before transmitting, generating an impulse using a different sensor to produce a tension signal in the net, and receiving the tension signal at the sensor, wherein the tension signal is the signal comprising information indicative of one or more net state parameters.

The method can further include providing, for display on a user interface, a graphical representation that depicts the net state and one or more net state parameters of the net state.

The method can further include generating an alert for display on a user interface.

The method can further include providing a graphical or textual representation of the defect in the net for display on a user interface.

The defect can be a hole, a bulge, a biofouling, or an animal.

The machine learning model can be an SVM, a GAN, an SOM, or an autoencoder.

The machine learning model can be trained on net state parameters from different aquaculture nets.

The method can further include commanding a camera drone to perform an inspection of the defect.

In a second aspect, disclosed herein is a net monitoring system, including: a plurality of net monitoring devices, each net monitoring device including: a housing; a plurality of tensioning arms, each tensioning arm reversibly extendable through the housing and configured to reversibly secure to a net, each tensioning arm including a force sensor configured to generate a tension signal indicative of a tension applied to the corresponding tensioning arm; a tensioning mechanism configured concurrently retract the plurality of tensioning arms into the housing; an impulse generating device, configured to generate an impulse responsive to a command; and a communications device configured to receive the tension signals from the plurality of force sensors, and transmit the tension signals through water; and a controller, having one or more processors; and one or more tangible, non-transitory computer readable media operably connectable to the one or more processors and storing instructions that, when executed, cause the one or more processors to perform operations including: command at least one of the plurality of net monitoring devices to generate the impulse; receive the tension signals responsive to the command to generate the impulse; and extract the information from the signal; apply the extracted information as input to a machine learning model trained to determine a net state from the extracted information; determine the presence of a defect in the net.

### Embodiments can Include the Following Features

The communications device and the controller can be configured to communicate with acoustic signals.

The communications device can be configured to encode the tension signals in a carrier signal.

The communications device can be configured to transmit the carrier signal through the water.

The plurality of net monitoring devices can be configured to transmit the tension signals on a regular schedule, an irregular schedule, in response to receiving a command to transmit the signals, or a combination thereof.

The plurality of net monitoring devices can further include a battery, and a power generation module.

The power generation module can include a piezoelectric device.

The piezoelectric device can be configured to generate power based on motion of the plurality of tensioning arms.

In a third aspect, disclosed herein is a system for monitoring an aquaculture net, including: one or more processors; and one or more tangible, non-transitory computer readable media operably connectable to the one or more processors and storing instructions that, when executed, cause the one or more processors to perform operations including: transmitting, from a sensor coupled to a net, a signal including information indicative of one or more net state parameters through water; receiving, by a controller including a receiver configured to receive signals from water, the signal; extracting the information from the signal; transmitting the information to a networked device communicatively coupled to the controller; applying the extracted information as input to a machine learning model trained to determine a net state from the extracted information; transmitting the net state to the controller; and providing, for display on a user interface, a graphical representation that depicts the net state and one or more net state parameters of the net state.

### Embodiments can Include the Following Features

The system can, before transmitting, generate an impulse using a different sensor to produce a tension signal in the net, and receive the tension signal at the sensor, wherein the tension signal is the signal comprising information indicative of one or more net state parameters.

The machine learning model can be an SVM, a GAN, an SOM, or an autoencoder.

Particular implementations of the subject matter described in this specification can be implemented so as to realize one or more of the following technical advantages.

The methods disclosed herein utilize machine learning language for active monitoring of aquaculture holding nets and producing an estimated net state model.

The methods disclosed herein facilitate passive monitoring of an aquaculture holding net which reduces the need for regularly scheduled monitoring by a user which can decreases the costs associated with net monitoring.

The machine learning models disclosed herein can be supervised, or unsupervised, learning models which can be updated according to large databases of similar nets while also estimating net states in the future from previously trained models.

The methods and devices disclosed herein can form a mesh network including a portion, or all, of the deployed net monitoring devices. Forming a mesh network between the deployed net monitoring devices increases the scalability of the net monitoring system to accommodate high numbers of devices for large nets as well as collecting additional data for input into a trained machine learning model.

The details of one or more embodiments are set forth in the accompanying drawings and the description below. Other features and advantages will be apparent from the description and drawings, and from the claims.

### DESCRIPTION OF DRAWINGS

FIG. 1A is a schematic diagram of an exemplary net monitoring system.

FIG. 1B is a schematic diagram of a second exemplary net monitoring system FIG. 2A is a top view schematic diagram of a net monitoring device.

FIG. 2B is a cut-away side view schematic diagram of the net monitoring device

FIG. 2C is a side view schematic diagram of the force sensor a tensioning arm of the net monitoring device.

FIG. 3 is a circuit diagram detailing an example arrangement of the circuitry of the net monitoring device.

FIGS. 4A-4C are oblique view schematic diagrams of a system of net monitoring devices producing a tension signal and communicating an acoustic signal to the control device.

FIG. 5 is a flow chart diagram of a low-power net monitoring method for a net monitoring device.

FIG. 6 is a flow chart diagram of a method for monitoring a net.

FIG. 7 is a flow chart diagram of another method for monitoring a net.

In the figures, like references indicate like elements.

### DETAILED DESCRIPTION

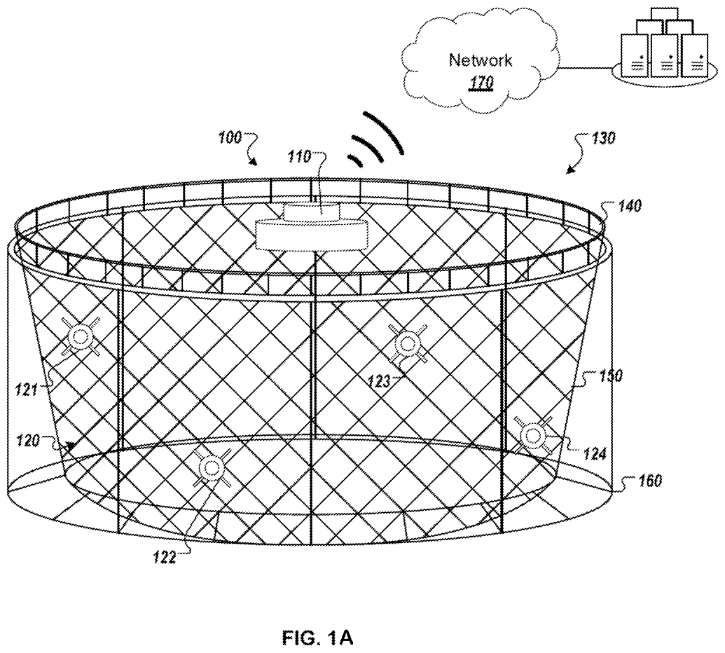

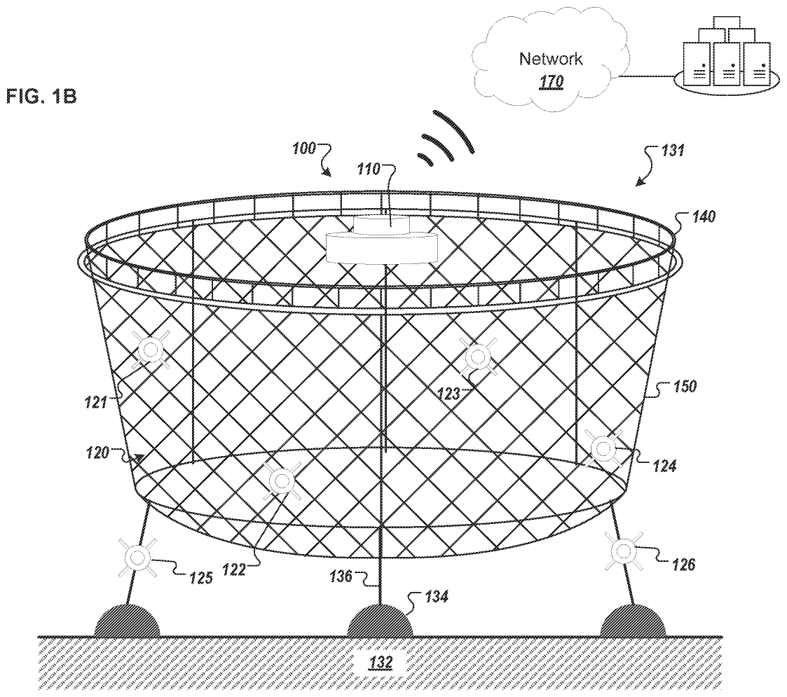

Shown in FIG. 1A is a net monitoring system 100 including a control device 110 and two or more net monitoring devices 120, e.g., net monitoring device 121, 122, 123, and 124. The net monitoring system 100 is configured to provide monitoring operations for a fish pen 130 in a body of water. Some examples of the fish pen 130 include weights, anchoring devices, or guy lines, for tensioning the strands, or maintaining the fish pen 130 in a fixed location in the body of water.

The fish pen 130 includes a net 150 made out of a meshed material. The fish pen 130 may be made from any appropriate materials including rope, metal, or synthetic materials including plastic. The meshed material has a network of holes between the meshed materials.

The fish pen 130 includes a gangway 140 which floats at the surface of the body of water in which the fish pen 130 is positioned. The gangway 140 provides a structure for tasks remaining to maintaining the fish pen 130 such as observation of the fish, feeding operations, docking of water vehicles, or travel around the perimeter of the pen.

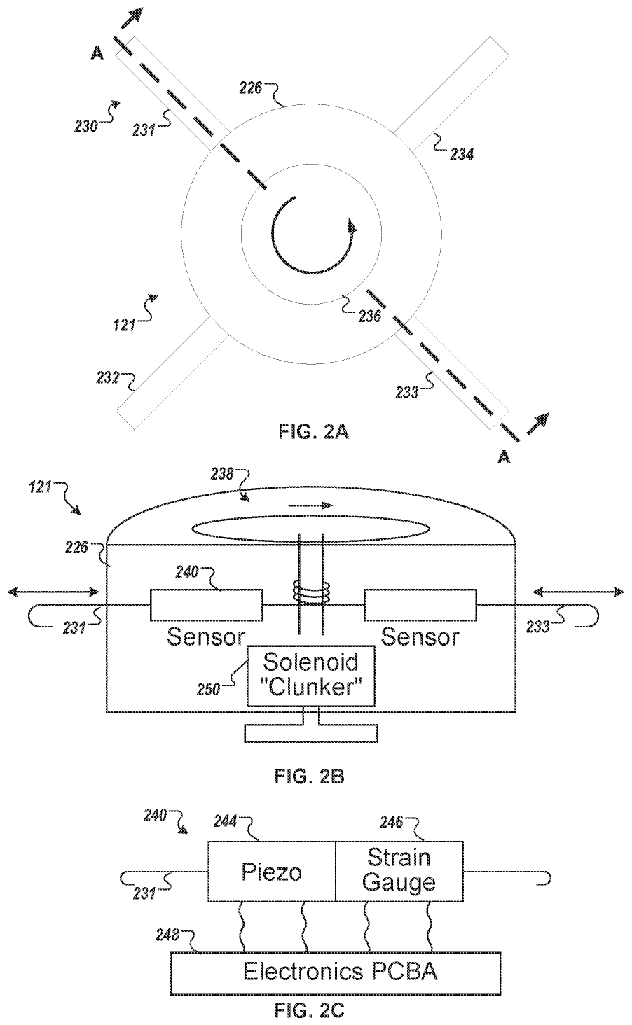

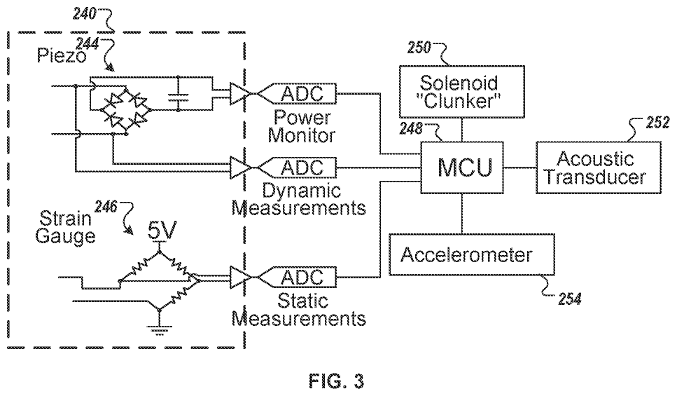

Reversibly attached to the net 150 are the net monitoring devices 120. Referring now to FIGS. 2A and 2B, the net monitoring device 121 is shown which can provide for any of the net monitoring devices 120. FIG. 2A shows a top-view of the net monitoring device 121 while FIG. 2B shows a cut-away view of the net monitoring device 121 along line A. The net monitoring device 121 has a housing 226 composed of a durable, non-reactive material suitable for use in underwater environments, which can include brackish water, salt water (e.g., brine), or freshwater environments. Examples of materials suitable for the housing 226 include plastic (e.g., polyvinyl chloride, or high-density polyethylene), or metals (e.g., stainless steel).

The housing 226 is configured to be resistant to liquid ingress when submerged. In some examples, the housing 226 is ingress protection (IP) rated (e.g., JP58, or JP68 rated). The housing 226 provides protection for sensors, an impulse generating device, and control circuitry.

Tensioning arms 230 extend from the side walls of the housing 226. The net monitoring device 121 includes four tensioning arms 230, e.g., arm 231, arm 232, arm 233, and arm 234. Four tensioning arms 230 facilitate stable attachment to the net 150. Pairs of the tensioning arms 230 extend in opposing directions from the housing 226 and are arranged to extend in orthogonal directions from the housing 226. Such an arrangement of the tensioning arms 230 allow the tensioning arms 230 to monitor tension in two orthogonal directions. Some examples of the net monitoring device 121 include more than four tensioning arms 230, e.g., five, six, eight, or more, tensioning arms 230.

The distal ends of the tensioning arms 230, e.g., the ends furthest from the housing, are shaped to traverse a hole and positively engage a strand of the net 150 when attached to the net 150 and the tensioning arms 230 are drawn into the housing 226. The distal end of the arm 234 has a hook-like shape such that when the distal end traverses a hole in the net and is drawn into the housing 226, the hook end engages a strand of the net and tension in the arm 234 is transferred to the strand and thereby into the net 150.

Extending from the top of the housing 226 is a tensioner protrusion 236 which is rotatable with respect to the housing 226, indicated by the arrow. The tensioner protrusion 236 is configured to be operated, e.g., rotated, by a hand of a user. For example, the tensioner protrusion 236 has a greatest dimension (e.g., a length or a diameter) in a range from 4 cm to 10 cm (e.g., 5 cm, 6 cm, 7 cm, or 8 cm). The tensioner protrusion 236 extends from the top of the housing 226 by a distance which facilitates hand operation by the user (e.g., 2 cm, 3 cm, 4 cm, or 5 cm). In the example of FIG. 2A, the housing 226 and the tensioner protrusion 236 are circular in shape, though this is exemplary and non-limiting.

The tensioner protrusion 236 is operably coupled to a tensioning mechanism 238 such that rotations of the tensioner protrusion 236 causes the tensioning mechanism 238 to alter the extension state of the tensioning arms 230, e.g., retract the tensioning arms 230 into, or extend the tensioning arms 230 from, the housing 226. In alternative examples, the tensioner protrusion 236 is depressible to cause tensioning mechanism 238 to alter the extension state of the tensioning arms 230.

In an example, a user secures the net monitoring device 121 on the net 150 by arranging the net monitoring device 121 such that the distal ends of the tensioning arms 230 extend through holes in the net 150. The user operates the tensioner protrusion 236 which causes the tensioning mechanism 238 to retract the tensioning arms 230 into the housing 226. The distal ends of the tensioning arms 230 engage with a strand of the net 150 as the tensioning arms 230 retract into the housing 226. The user continues to operate the tensioner protrusion 236 and retract the tensioning arms 230 into the housing 226 until the tensioning arms 230 are retracted by a distance sufficient to cause increased tension in the net 150.

In an example, the user removes the net monitoring device 121 from the net 150 by rotating the tensioner protrusion 236 in a second direction (e.g., a second direction opposite to the first direction) which causes the tensioning mechanism 238 to extend the tensioning arms 230 from the housing. The user rotates the tensioner protrusion 236 until the tensioning arms 230 disengage from the net 150 and no longer cause increased tension in the net 150. The user then manipulates the net monitoring device 121 such that the distal ends of the tensioning arms 230 are removed from the respective holes of the net 150.

Each of the tensioning arms 230 includes a sensor array 240 which includes a piezoelectric generator 244 and a strain gauge 246, e.g., a force sensor. The piezoelectric generator 244 converts kinetic energy in the form of motion, e.g., vibration, translation, or shocks, into electrical energy. The piezoelectric generator 244 is in electrical connection with an onboard controller 248 which includes a power source, e.g., a battery, of the net monitoring device 121 such that the piezoelectric generator 244 provides power to the power source. In such examples, the net monitoring device 121 is passively powered when affixed to the net 150.

The strain gauge 246 is arranged on the arm 231 to monitor tension forces along the longitudinal axis of the arm 231. Tension forces in the arm 231 cause the strain gauge 246 to generate tensions signals indicative of the tension force in the arm 231. The strain gauge 246 is connected to the onboard controller 248 which receives the tension signals from the strain gauge 246. The onboard controller 248 stores the tensions signals in a storage device, e.g., memory. The strain gauge 246 has a wide frequency bandwidth to detect not just static tension, e.g., normal net dynamics, but also high-frequency net dynamics, e.g., strain frequencies above . . . .

The net monitoring device 121 includes an impulse generating device 250 which generates an impulse, e.g., a sudden acceleration motion. An example of the impulse generating device 250 includes a two-state solenoid. The impulse generating device 250 receives commands from the onboard controller 248 to generate an impulse and the impulse generating device 250 generates the impulse in response to the command. The impulse generated by the impulse generating device 250 causes an acceleration in the net monitoring device 121.

FIG. 1B shows the net monitoring system 100 installed on a second exemplary fish pen 131 which is anchored to one or more bases 134 via lines 136. The bases 134 are affixed to the ground 132 such that the position of the net 150 is maintained with respect to the ground 132. In the example of FIG. 1B, the net monitoring system 100 includes net monitoring devices 125 and 126 which are attached to different lines 136. The net monitoring devices 125 and 126 receive information related to tension forces in the lines 136 and transmit the information to the net monitoring system 100, e.g., to the control device 110, or to networked net monitoring devices 120. In such configurations, the net monitoring devices 125 and 126 receive the tension information through a pair of arms 230 connected to the lines 136 in a one-dimensional configuration while arms 230 which are not connected are ignored, e.g., signals received through the arms 230 are not processed by the onboard controller 248.

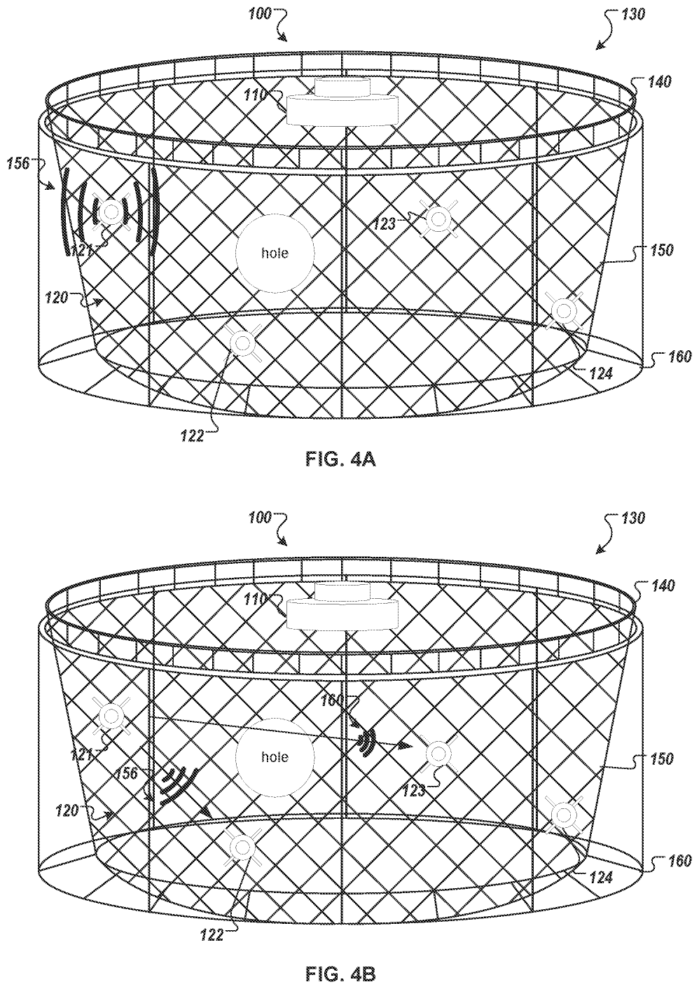

FIG. 3 shows an example circuit diagram of the onboard controller 248 of the net monitoring device 121. The onboard controller 248 is in electrical communication with the sensor array 240, including the piezoelectric generator 244 and the strain gauge 246. The onboard controller 248 receives power from the piezoelectric generator 244 and stores the power in the power source. The onboard controller 248 receives tension signals from the strain gauge 246 and stores the tension signals in memory.

The net monitoring device 121 includes an accelerometer 254 which generates an acceleration signal indicative of an acceleration force on the accelerometer 254. The accelerometer 254 is in electrical communication with the onboard controller 248 which receives the acceleration signal from the accelerometer 254. In some examples, the onboard controller 248 stores the acceleration signal in the storage device.

The onboard controller 248 is in electrical connection with a communications device, e.g., acoustic transducer 252, e.g., an acoustic modem. The onboard controller 248 is configured to encode one or more signals, such as the tension signal, or the acceleration signal, into a carrier signal. The acoustic transducer 252 is configured to transmit and receive signals through a liquid medium, e.g., the water surrounding the net monitoring device 121. For example, the acoustic transducer 252 receives the carrier signal from the onboard controller 248 and transmits the carrier signal through the water surrounding the net monitoring device 121. In alternative examples, the acoustic transducer 252 receives the one or more signals from the onboard controller 248 and encodes the one or more signal into the carrier signal and transmits the carrier signal through the water.

In some examples, the acoustic transducer 252 is a low-power acoustic transducer 252 which is configured to utilize electronics having low power requirements, include firmware or software to utilize low-power states, or a combination of both. For example, the acoustic transducer 252 can utilize . . . .

In some examples, the net monitoring device 121 is configured to form a mesh network with nearby net monitoring devices 120. In general, a mesh network is a local area network topology in which the infrastructure nodes, e.g., the net monitoring devices 120, connect directly, dynamically and non-hierarchically. The net monitoring device 121 is configured to create, participate, or both, in the mesh network to extend communication range for the net monitoring devices 120 participating in the mesh network. For example, the net monitoring device 121 participating in the mesh network may relay messages to or from the control device 110 to net monitoring devices 120 which are out of communications range of the control device 110 when not participating in the mesh network.

The control device 110 is configured to communicate with networked devices over network 170, such as a cloud network, through wired and/or wireless communications. The networked devices can include a computing system that includes a back-end component, e.g., as a data server, on which the machine learning (ML) model is implemented. The net state ML system can perform an analysis determine quantitative differences between various net state parameters and, after a period of training, provide classifications of one or more parameters of a net state, including net defects, and net topologies, and force topologies. In some embodiments, the ML model is trained on a networked device, and the trained ML model implemented on the net monitoring system 100 for local processing.

As used herein, the term ‘topology’ can refer to net topologies which describe the physical state of the net, such as a three-dimensional shape, the presence of bulges, or time-dependent shape dynamics. The net topology can be altered by occurrences such as lice skirts, and/or ocean currents. Alternatively, the term ‘topology’ can refer to force topologies, the network of force data which connects the net monitoring devices 120 across the fish pen 130.

In general, the net state is a data structure containing values for various net state parameters received from the net monitoring system 100. For example, each of the net monitoring devices 120 monitors tension forces on the strands of the net in one or more dimensions which can be stored in the net state and input into the ML model. Other net state parameters which can be stored in the net state include (1) information from the tension signals, e.g., forces, directions, characteristic frequencies, and/or (2) context about net's environment, e.g., water temperatures, atmospheric conditions (barometric pressure), wind speeds, flow rates, presence of wildlife, or salinity.

In general, a variety of ML models can be used to perform the net state analysis. In some embodiments, the ML net state analysis model is a neural network which employs one or more layers of nonlinear units to determine one or more net parameters, given a sequence of tension data received from the control device 110. A variety of neural networks can be used to analyze and classify the tension data. In some examples, the data received from the net monitoring devices 120 can be pre-processed and provided to the ML models in different forms, such that that different types of ML models can be supported.

In one example, the force sensor data is recorded during a small window of time, an FFT is performed (e.g., by the onboard controller 248 and/or by the control device 110) to generate frequency-space data, and the frequency-space data fed into an ML-based anomaly detector. This process can be supported by generative adversarial networks (GANs), one-class support vector machines (SVMs), self-organizing maps (SOMs), and autoencoders. These anomaly-detection techniques reduce the high-dimensional input data to a simple binary network output.

Small windows of data, e.g., the data transmitted in a single awake cycle of each of the nearby net monitoring devices 120, may not provide enough signal to the detector. In such cases, the force measurements are communicated to the ML model in an ongoing sequence. In this case, the model would likely include convolutional neural network (CNN) techniques for filtering and recurrent neural network (RNN) techniques for memory.

In some implementations, lower dimensional models, e.g., a multilayer perceptron or autoencoder, can be implemented. The minimum number of features that can be used to achieve acceptable accuracy in determining the net state is preferred for computational simplicity. Optimized models may be trained or simulated in constrained computing environments in order to maximize speed, power, or interpretability. Three primary features of optimization are (1) the number of features extracted, (2) the “depth” (number of hidden layers) of the model, and (3) whether the model implements recurrence. These features are balanced in order to achieve the highest possible accuracy while still allowing the system to operate in near real time on the embedded hardware.

The neural network may be a deep neural network that includes two or more hidden layers in addition to the input and output layers. The output of each hidden layer is used as input to another layer in the network, i.e., another hidden layer, the output layer, or both. Some layers of the neural network may generate an output from a received input, while some layers do not, e.g., the layers remain “hidden.” The network may be recurrent or feedforward. It may have a single output or an ensemble of outputs, it may have an ensemble of architectures with a single output or a single architecture with a single output. In some embodiments, the ML net state analysis model may have added convolutional layers that represent filters so that the EEG signals can be cleaned and processed by the same ML model.

In some embodiments, the ML model uses a subselection of features in which the model only compares the current net state with other net state parameters, e.g., previously sample net state parameters, or parameters from other net monitoring systems 100, that are similar to that of the net 150 in order to determine a net state. Similarity to another net, such as a net or net monitoring system deployed at a different location, can be operationalized with standard techniques such as waveform convolution and normalized cross correlation.

Alternatively, the ML net state analysis model compares the net state parameters to a large dataset of previously received net state models (e.g., in an embodiment that employs a nearest-neighbor-type of model). The dataset may contain labeled net state parameter samples from one or more other nets.

In general, ML models for net state analysis can be trained on net parameters in order to determine or infer patterns of net state activity and progression, e.g., how one or more net state parameters may evolve through time, or inferred between one or more measured timepoints. Once the model is trained broadly across multiple situations and outcomes, the system can use the ML model on any net for a net state analysis without further training. In some embodiments, the more similar the new situation or outcome is to a trained situation or outcome, the more effective this transfer will be. However, in certain embodiments, ML models can return accurate results based on novel data on which it has not been trained. However, in some implementations, the ML model is a pre-trained model.

In further examples, the fish pen 130 shape/structure is estimated using a combination of ML and non-ML algorithms. Autoencoders and GANs can be used, and combined with supporting information about how the system is expected to behave in the future.

To train the ML net state analysis model, the system 100 provides the model with values from the net state parameter stored by the system 100. One example of training the ML net state analysis model includes passive training, in which the net monitoring devices 120 spend a period of time (e.g., anywhere from several minutes, up to 1 day) passively monitoring the fish pen 130. This facilitates monitoring how wind, waves, and other equipment affect the known-good net. The ML net state analysis model then uses this information to filter out noise and detect substantial changes to the operating environment.

Another example includes active training, in which the net monitoring devices 120 take turns pulsing respective impulse generating devices 250; the nearby net monitoring devices 120 receive and record each pulse from the known-good fish pen 130. When deployed on the fish pen 130, each respective impulse generating device 250 produces a slightly different force on the fish pen 130 which can be quantified by performing a fast Fourier transform (FFT) on the sensor measurements to get information on both the strength and frequency distribution on the transmitted forces. By learning these measurements, the net monitoring systems 100 can estimate the force topology of the net and then perform anomaly detection to detect substantial changes.

In some embodiments, the information sent to the ML net state analysis model is supplemented by at least information provided by one or more net-monitoring personnel to provide additional context to the transmitted information. Contextual information may include information about the net, the net's current environment, information concerning animals within the pen (e.g., a species, a count), and/or other useful information that can be used to determine one or more parameters of the net state, e.g., where the net is located, the presence of one or more net monitoring devices 120 within the mesh network, information from cameras, the current time, and the current weather.

The control device 110 can include an alerting system implemented in on-board electronics which monitors the estimated net state for anomalies. The control device 110 receives the acoustic signal and triggers emergency net inspections or repairs based on the presence or level of one or more values communicated by the acoustic signal. Alternatively, the alerting system can be implemented by computers connected to the network 170, and the alerts transmitted to the control device 110.

In some examples, the alerting system can include the following implementations:

OpenCensus metrics that can be scraped by monitoring systems configured to collect such metrics, such as Prometheus. For example, Google Cloud has products that support scraping, monitoring, and alerting on these metrics.

A built-in LTE modem can generate email and SMS alerts to customer-configured addresses.

A light on the control device 110 that is visible from a nearby feeding barge and which is indicative of the net needing to be inspected immediately for possible damage and/or fish escape by any nearby farmers.

The net monitoring systems 100 can communicate with flying, surface, or underwater drones to direct them to inspect one or more sections of the fish pen 130. Flying or surface drones can monitor upper sections of the fish pen 130 and an underwater drone would by useable to inspect underwater sections of the fish pen 130.

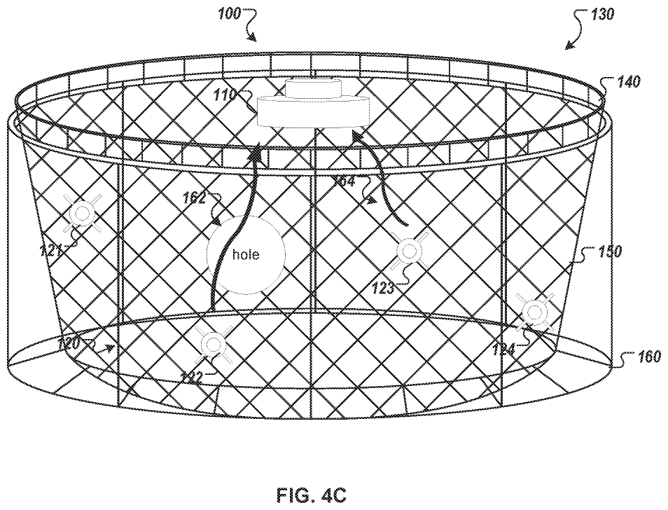

FIGS. 4A-4C schematically illustrate the process by which the net monitoring system 100 generates impulse signals in the net 150, monitors tension signals indicative of the impulse signal traveling through the strands of the net 150, and communicates information to the control device 110. In the diagram of FIG. 4A, net monitoring device 121 commands the impulse generating device 250 to generate an impulse. The impulse generating device 250 generates an impulse which is communicated through the tensioning arms 230 to the strands of the net 150.

As shown in FIG. 4B, the impulse signal 156 traverses the strands of the net 150. In general, the impulse signal 156 traverses the strands of the net 150 omnidirectionally. Two paths of the impulse signal 156 are shown: the first path between the net monitoring device 121 and the net monitoring device 122, and the second path between net monitoring device 121 and the net monitoring device 123, though the paths are exemplary and non-limiting.

The impulse signal 156 traverses the strands of the net 150 along the first path and arrives at the location at which the net monitoring device 122 is secured to strands of the net 150. The impulse signal 156 causes tension forces in the tensioning arms 230 of the net monitoring device 122 which transmit signals to the onboard controller 248 indicative of the impulse signal 156.

The impulse signal 156 traverses the strands of the net 150 along the second path and is disrupted by a defect, e.g., a hole in the net. Examples of defects include a hole, e.g., severed strands, (as in FIGS. 4A-4C), a bulge (e.g., an area of the net 150 in which tension is increased or decreased from average), biofouling (e.g., biomatter buildup, seaweed, or algal growth), fraying, or an entangled animal (e.g., an entangled fish, or an entangled predator). The second path is shown linearly traversing the defect, though in general the impulse signal 156 traverses the network of strands surrounding a hole.

The disrupted impulse signal 160 is received by the net monitoring device 123 as increased tension forces in the tensioning arms 230 which transmit tension signals to the onboard controller 248 indicative of the disrupted impulse signal 160. The onboard controller 248 of net monitoring device 122 and net monitoring device 123 encode the tension signals indicative of the impulse signal 156 and the disrupted impulse signal 160, respectively, into a carrier signal and provides the carrier signal to the acoustic transducers 252.

The acoustic transducers 252 generates an acoustic signal and transmits the carrier signals, e.g., carrier signal 162 and carrier signal 164, into the water surrounding net monitoring device 122 and net monitoring device 123. The carrier signals are shown as lines directed at the control device 110 though this is for ease of reference, and is not representative of the directionality in which the carrier signals are transmitted in the water. In general, the carrier signals are transmitted by the acoustic transducers 252 omnidirectionally.

The control device 110 is arranged to receive acoustic signals transmitted in the water. For example, the control device 110 is depicted partially submerged in the water within the fish pen 130 of FIG. 4C. In some examples, the control device 110 may be mounted, releasably attached, or anchored to the gangway 140 and an acoustic transducer partially or fully submerged in the water to receive transmitted signals.

The control device 110 receives acoustic signals, e.g., the carrier signals, transmitted through the water. The control device 110 determines from the received signal the presence of the hole.

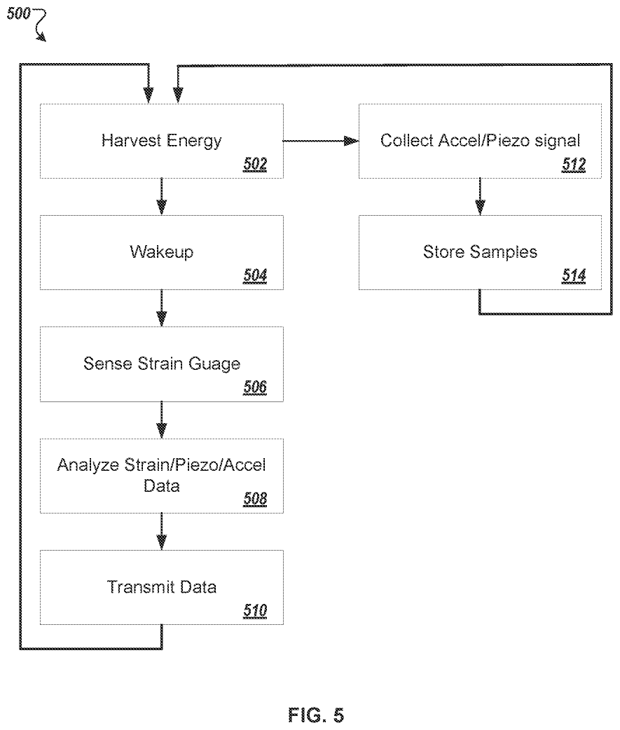

The net monitoring system 100 is substantially self-sufficient, e.g., the net monitoring devices 120 generate power from motion of the tensioning arms 230, communicate sparsely with the net monitoring system 100, and maintain tension in the strands of the fish pen 130 between tensioning operations by the user. FIG. 5 is a flow chart diagram of an example process by which the net monitoring system 100 performs the net monitoring.

In general, the net monitoring devices 120 operate in a low-power mode during which the net monitoring devices 120 generate energy (step 502) from motion of the tensioning arms 230 induced from the surroundings, e.g., from wave energy, or motion of the strands on which the tensioning arms 230 attach. The piezoelectric generator 244 generates energy based on the motion and the net monitoring devices 120 stores the generated energy in a power storage device (e.g., a battery).

At some times, the net monitoring devices 120 enters an active mode during which detection, analysis, and communication processes are performed. The times at which the net monitoring devices 120 enter the active mode can be regularly scheduled (e.g., daily or weekly at a specific time), irregularly or intermittently scheduled (e.g., daily at random times), random (e.g., randomly generated times), triggered (e.g., when a certain condition is met, such as a total power stored or the detection of a defect, or when a command is received to enter active mode), or a combination.

The net monitoring devices 120 performs a wakeup process (step 504). The wakeup process can include, but is not limited to, providing power to previously de-powered components, or performing self-analysis on one or more components (e.g., troubleshooting, communication of error messages).

The net monitoring devices 120 receive signals from the strain gauge 246 (step 506). The tension in the tensioning arms 230 causes strain in the strain gauge 246 which the sensor array 240 transmits to the onboard controller 248 as a strain signal.

The net monitoring devices 120 analyze the received data (step 508). The onboard controller 248 analyzes signals from the sensor array 240, the strain gauge 246, the piezoelectric generator 244, the acoustic transducer 252, the impulse generating device 250, the accelerometer 254, combinations thereof, or other components providing data to the onboard controller 248. In some examples, the onboard controller 248 analyzes signals that were stored during step 502, signals that were received following the step 504, or both.

The net monitoring devices 120 transmit data into the surrounding water (step 510). The onboard controller 248 provides a signal to the acoustic transducer 252 which embeds the signal into a carrier signal and transmits the carrier signal into the surrounding water. The net monitoring devices 120 return to low-power, e.g., harvest energy, mode (step 502)

In general, the net monitoring devices 120 can perform steps 504, 506, 508, or 510 in any order. In some examples, the net monitoring devices 120 perform a process having fewer steps. For example, the net monitoring devices 120 collect data from a subset of the signals from the internal components without transmitting data from the acoustic transducer 252. In one example, the net monitoring devices 120 collect data from the piezoelectric generator 244, the accelerometer 254, or both (step 512).

In such an example, the onboard controller 248 stores the collected data from the subset of the signals (step 514) in an onboard storage device. The net monitoring devices 120 return to low-power, e.g., harvest energy, mode (step 502).

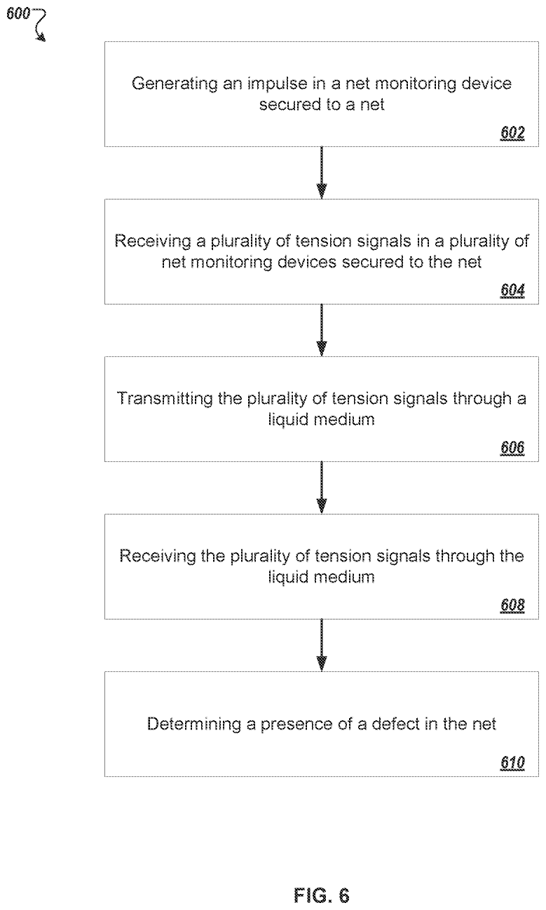

Provided herein is a method for monitoring a fish net. FIG. 6 is a flow chart diagram showing the method 600. The method includes generating an impulse in a net monitoring device secured to a net (step 602). The net monitoring devices 120 generate an impulse with the impulse generating device 250. The impulse is communicated to the strands of a net through the tensioning arms 230.

The method includes receiving a plurality of tension signals in a plurality of net monitoring devices secured to the net (step 604). The tension in the strands of the net 150 communicate the tension signal (e.g., the impulse signal) along the strand network. The impulse signal cause motion in the tensioning arms 230 of at least a second of the net monitoring devices 120. The impulse signal is received by the sensor array 240 of the tensioning arms 230 and communicated to the onboard controller 248.

The method includes transmitting the plurality of tension signals through a liquid medium (step 606). The impulse signal is embedded in a carrier signal and communicated into a liquid medium (e.g., water) surrounding the net monitoring devices 120. The acoustic transducer 252 communicates the carrier signal into the surrounding water.

The method includes receiving the plurality of tension signals through the liquid medium (step 608). The control device 110 is arranged to receive acoustic signals transmitted through the liquid medium, e.g., the water. The control device 110 receives the carrier signal from the water.

The method includes determining a presence of a defect in the net (step 610). The control device 110 receives the carrier signal and decodes the data transmitted from the net monitoring devices 120 through the water from the carrier signal. The control device 110 analyzes the transmitted data to determine the presence of a defect in the net 150.

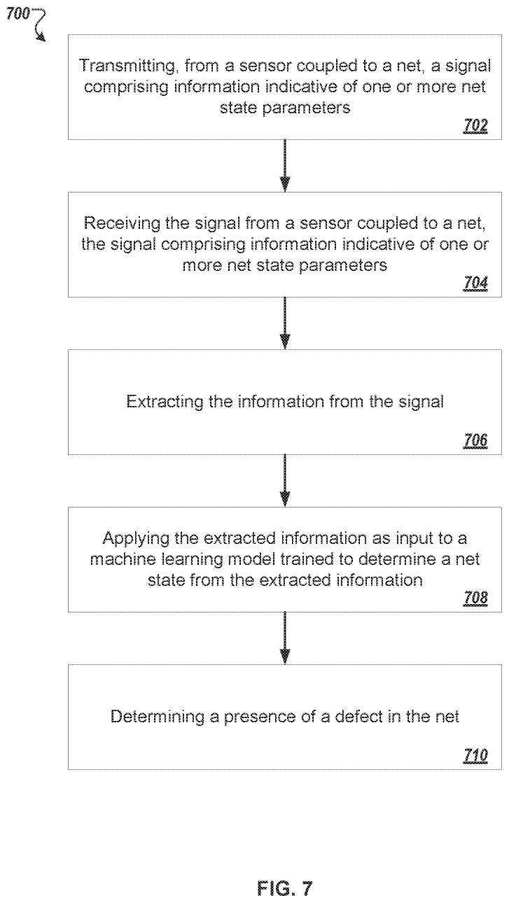

Provided herein is a method for monitoring an aquaculture net using a machine learning model. The method can be implemented on the net monitoring system 100 described herein. FIG. 7 is a flow chart diagram showing the method 700. The method includes transmitting a signal including information indicative of one or more net state parameters through water (step 702). In general, the net monitoring devices 120 coupled to a net transmit the information received from the respective sensor arrays 240 using the acoustic transducers 252 into the surrounding water. Said another way, the impulse signal is embedded in a carrier signal and communicated into the water surrounding the net monitoring devices 120.

The method includes receiving the signal including information indicative of the one or more net state parameters (step 704). The control device 110 receives the carrier signal transmitted through the water.

The method includes extracting the information from the signal (step 706). In some examples, the control device 110 extracts one or more net state parameters from the carrier signal.

The method includes applying the extracted information as input to a machine learning model trained to determine a net state from the extracted information (step 708). In some examples, the control device 110 applies the extracted information as input to the trained ML model. In other examples, the control device 110 communicates the extracted information over the network 170 to a networked device which applies the extracted information as input to the trained ML model.

The method includes determining a presence of a defect in the net (step 710). The control device 110 receives information indicative of one or more defects in the net as output from the trained ML model. In some examples, the control device 110 receives the output (e.g., the classification) from the networked devices over the network 170.

The following disclosure is an example computer system which can provide one or more components of the example system 100 described here, e.g., the control device 110, the net monitoring devices 120, or the onboard controller 248. For example, the system includes a processor, a memory, a storage device, and one or more input/output interface devices. Each of the components can be interconnected, for example, using a system bus.

The processor is capable of processing instructions for execution within the system. The term “execution” as used here refers to a technique in which program code causes a processor to carry out one or more processor instructions. In some implementations, the processor is a single-, or multi-threaded processor. The processor is capable of processing instructions stored in the memory or on the storage device.

The memory stores information within the system. In some implementations, the memory is a computer-readable medium. In some implementations, the memory is a volatile memory unit. In some implementations, the memory is a non-volatile memory unit.

The storage device is capable of providing mass storage for the system. In some implementations, the storage device is a non-transitory computer-readable medium. In various different implementations, the storage device can include, for example, a hard disk device, an optical disk device, a solid-state drive, a flash drive, magnetic tape, or some other large capacity storage device. In some implementations, the storage device may be a cloud storage device, e.g., a logical storage device including one or more physical storage devices distributed on a network and accessed using a network.

The input/output interface devices provide input/output operations for the system. In some implementations, the input/output interface devices can include one or more of network interface devices, e.g., an Ethernet interface, a serial communication device, e.g., an RS-232 interface, and/or a wireless interface device, e.g., an 802.11 interface, a 3G wireless modem, a 4G wireless modem, etc.

Software can be realized by instructions that upon execution cause one or more processing devices to carry out the processes and functions described above, for example, monitoring defects in nets. Such instructions can include, for example, interpreted instructions such as script instructions, or executable code, or other instructions stored in a computer readable medium.

In some examples, the system is contained within a single integrated circuit package. A system of this kind, in which both a processor and one or more other components are contained within a single integrated circuit package and/or fabricated as a single integrated circuit, is sometimes called a microcontroller. In some implementations, the integrated circuit package includes pins that correspond to input/output ports, e.g., that can be used to communicate signals to and from one or more of the input/output interface devices.

Although an example processing system has been described, implementations of the subject matter and the functional operations described above can be implemented in other types of digital electronic circuitry, or in computer software, firmware, or hardware, including the structures disclosed in this specification and their structural equivalents, or in combinations of one or more of them. Implementations of the subject matter described in this specification, such as storing, maintaining, and displaying data can be implemented as one or more computer program products, i.e., one or more modules of computer program instructions encoded on a tangible program carrier, for example a computer-readable medium, for execution by, or to control the operation of, a processing system. The computer readable medium can be a machine-readable storage device, a machine-readable storage substrate, a memory device, or a combination of one or more of them.

The term “system” may encompass all apparatus, devices, and machines for processing data, including by way of example a programmable processor, a computer, or multiple processors or computers. A processing system can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, executable logic, or code) can be written in any form of programming language, including compiled or interpreted languages, or declarative or procedural languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code).

Computer readable media suitable for storing computer program instructions and data include all forms of non-volatile or volatile memory, media and memory devices, including by way of example semiconductor memory devices, e.g., EPROM, EEPROM, and flash memory devices; magnetic disks, e.g., internal hard disks or removable disks or magnetic tapes; magneto optical disks; and CD-ROM, DVD-ROM, and Blu-Ray disks. The processor and the memory can be supplemented by, or incorporated in, special purpose logic circuitry.

While this specification contains many details, these should not be construed as limitations on the scope of what may be claimed, but rather as descriptions of features specific to particular examples. Certain features that are described in this specification in the context of separate implementations can also be combined. Conversely, various features that are described in the context of a single implementation can also be implemented in multiple embodiments separately or in any suitable subcombination.

A number of implementations have been described. Nevertheless, it will be understood that various modifications may be made without departing from the spirit and scope of the invention. Accordingly, other implementations are within the scope of the following claims.

What is claimed is:

1. A method for monitoring an aquaculture net, comprising:
transmitting, from a sensor coupled to a net, a signal comprising information indicative of one or more net state parameters through water;
receiving the signal from a sensor coupled to a net, the signal comprising information indicative of one or more net state parameters;
extracting the information from the signal;
applying the extracted information as input to a machine learning model trained to determine a net state from the extracted information;
determining a presence of a defect in the net.

2. The method of claim 1, further comprising, before transmitting, generating an impulse using a different sensor to produce a tension signal in the net, and receiving the tension signal at the sensor, wherein the tension signal is the signal comprising information indicative of one or more net state parameters.

3. The method of claim 1, further comprising providing, for display on a user interface, a graphical representation that depicts the net state and one or more net state parameters of the net state.

4. The method of claim 1, further comprising generating an alert for display on a user interface.

5. The method of claim 1, further comprising providing a graphical or textual representation of the defect in the net for display on a user interface.

6. The method of claim 5, wherein the defect is a hole, a bulge, a biofouling, or an animal.

7. The method of claim 1, wherein the machine learning model is an SVM, a GAN, an SOM, or an autoencoder.

8. The method of claim 1, wherein the machine learning model is trained on net state parameters from different aquaculture nets.

9. The method of claim 1, further comprising commanding a camera drone to perform an inspection of the defect.

10. A net monitoring system, comprising:
a plurality of net monitoring devices, each net monitoring device comprising:
a housing;
a plurality of tensioning arms, each tensioning arm reversibly extendable through the housing and configured to reversibly secure to a net, each tensioning arm comprising a force sensor configured to generate a tension signal indicative of a tension applied to the corresponding tensioning arm;
a tensioning mechanism configured concurrently retract the plurality of tensioning arms into the housing;
an impulse generating device, configured to generate an impulse responsive to a command; and
a communications device configured to receive the tension signals from a plurality of force sensors, and transmit the tension signals through water; and
a controller, having one or more processors; and
one or more tangible, non-transitory computer readable media operably connectable to the one or more processors and storing instructions that, when executed, cause the one or more processors to perform operations comprising:
command at least one of the plurality of net monitoring devices to generate the impulse;
receive the tension signals responsive to the command to generate the impulse; and
extract the information from the signal;
apply the extracted information as input to a machine learning model trained to determine a net state from the extracted information;
determine a presence of a defect in the net.

11. The net monitoring system of claim 10, wherein the communications device and the controller are configured to communicate with acoustic signals.

12. The net monitoring system of claim 10, wherein the communications device is configured to encode the tension signals in a carrier signal.

13. The net monitoring system of claim 12, wherein the communications device is configured to transmit the carrier signal through the water.

14. The net monitoring system of claim 10, wherein the plurality of net monitoring devices are configured to transmit the tension signals on a regular schedule, an irregular schedule, in response to receiving a command to transmit the signals, or a combination thereof.

15. The net monitoring device of claim 10, further comprising a battery, and a power generation module.

16. The net monitoring device of claim 15, wherein the power generation module comprises a piezoelectric device.

17. The net monitoring device of claim 16, wherein the piezoelectric device is configured to generate power based on motion of the plurality of tensioning arms.

18. A system for monitoring an aquaculture net, comprising:
one or more processors; and
one or more tangible, non-transitory computer readable media operably connectable to the one or more processors and storing instructions that, when executed, cause the one or more processors to perform operations comprising:
transmitting, from a sensor coupled to a net, a signal comprising information indicative of one or more net state parameters through water;
receiving, by a controller comprising a receiver configured to receive signals from water, the signal;
extracting the information from the signal;
transmitting the information to a networked device communicatively coupled to the controller;
applying the extracted information as input to a machine learning model trained to determine a net state from the extracted information;
transmitting the net state to the controller; and
providing, for display on a user interface, a graphical representation that depicts the net state and one or more net state parameters of the net state.

19. The system of claim 18, further comprising, before transmitting, generating an impulse using a different sensor to produce a tension signal in the net, and receiving the tension signal at the sensor, wherein the tension signal is the signal comprising information indicative of one or more net state parameters.

20. The system of claim 18, wherein the machine learning model is an SVM, a GAN, an SOM, or an autoencoder.
